(19) United States
(12) Patent Application Publication
(10) Pub. No.: US 2019/0101178 A1
(43) Pub. Date: Apr. 4, 2019

(54) DAMPER WITH HYDRAULICALLY-ADJUSTABLE PRELOAD AND/OR CROSS-OVER

(71) Applicant: Fox Factory, Inc., Scotts Valley, CA (US)

(72) Inventors: Grant Skognes, Scotts Valley, CA (US); Christopher Paul Cox, Capitola, CA (US)

(73) Assignee: Fox Factory, Inc., Scotts Valley, CA (US)

(21) Appl. No.: 16/144,819

(22) Filed: Sep. 27, 2018

Related U.S. Application Data
(60) Provisional application No. 62/565,982, filed on Sep. 29, 2017.

(51) Int. Cl. F16F 9/46; F16F 13/00; B60G 17/08

(52) U.S. Cl. CPC F16F 9/464; B60G 17/08; F16F 13/007

(57) ABSTRACT

A damper having a hydraulically-adjustable preload. The damper includes a main damper cylinder, a damping piston and a damping rod movable within the main damper cylinder. A surface feature and a sleeve with a preload flange are coupled to a portion of an exterior surface of the main damper cylinder. The sleeve is movable with respect to the surface feature in a direction along the axis of the main damper cylinder. A spring is located surrounding a portion of the external surface of the main damper cylinder, and has one end abutting the preload flange and another end coupled to the damper. The sleeve and the surface feature are disposed such that a change in an amount of hydraulic fluid between the sleeve and the surface feature causes the preload flange to change a preload on the spring.

### CROSS-REFERENCE

This application claims priority to and the benefit of co-pending U.S. Provisional Patent Application 62/565,982 filed on Sep. 29, 2017, entitled “DAMPER WITH HYDRAULICALLY-ADJUSTABLE PRELOAD AND/OR CROSS-OVER” by Grant Skognes, the disclosure of which is hereby incorporated herein by reference in its entirety.

### FIELD OF THE INVENTION

Embodiments of the present technology relate generally to a damper including a coil spring or a plurality of coil springs, wherein the coil spring, or the plurality of coil springs, affects the damping characteristics of the damper.

### BACKGROUND

Certain shock absorbers utilize a coil spring or a plurality of coil springs to affect operating characteristics of the damper. Typically, to vary the operating characteristics of the damper, manual adjustments are made by a user of the damper directly at the location of the coil spring or the plurality of coil springs. Such manual adjustments can be difficult and sometimes dangerous to perform. Additionally, in a multi-wheeled vehicle, the user may be required to make such manual adjustments to each damper (or set of dampers) located at each wheel of the multi-wheeled vehicle.

### BRIEF DESCRIPTION OF THE DRAWINGS

Aspects of the present invention are illustrated by way of example, and not by way of limitation, in the accompanying drawings, wherein:

FIG. 1 is a cut-away view of a damper with hydraulically-adjustable preload, in accordance with an embodiment of the present invention.

FIG. 2 is a cut-away view of the damper with hydraulically-adjustable preload of FIG. 1, wherein the coil spring is more compressed than it is in FIG. 1, in accordance with an embodiment of the present invention.

FIG. 3 includes a schematic view of four dampers with hydraulically-adjustable preload located at respective wheels of a four-wheeled vehicle and wherein each of the dampers are coupled to a central hydraulic unit, in accordance with an embodiment of the present invention.

FIG. 4 is a cross-sectional view of a damper with hydraulically-adjustable cross-over, in accordance with an embodiment of the present invention.

FIG. 5A is a partial cut-away view of a damper with hydraulically-adjustable cross-over, in accordance with an embodiment of the present invention.

FIG. 5B is a partial cut-away view of the damper with hydraulically-adjustable cross-over of FIG. 5A, wherein the damper is more compressed than depicted in FIG. 5A, in accordance with an embodiment of the present invention.

FIG. 5C is a partial cut-away view of the damper with hydraulically-adjustable cross-over of FIG. 5A, wherein the damper is more compressed than depicted in FIG. 5B, in accordance with an embodiment of the present invention.

FIG. 5D is a partial cut-away view of the damper with hydraulically-adjustable cross-over of FIG. 5A, wherein the damper is more compressed than depicted in FIG. 5C, in accordance with an embodiment of the present invention.

FIG. 6A provides a view of a damper with hydraulically-adjustable cross-over (with springs included), in accordance with an embodiment of the present invention.

FIG. 6B provides a view of a damper with hydraulically-adjustable cross-over (with springs included), in accordance with an embodiment of the present invention.

FIG. 6C provides a view of a damper with hydraulically-adjustable cross-over (with springs included), in accordance with an embodiment of the present invention.

FIG. 7A provides a view of a damper with hydraulically-adjustable cross-over, in accordance with an embodiment of the present invention.

FIG. 7B provides a view of a damper with hydraulically-adjustable cross-over (with springs included), in accordance with an embodiment of the present invention.

FIG. 7C provides a view of a damper with hydraulically-adjustable cross-over (with springs included), in accordance with an embodiment of the present invention.

FIG. 8 is a cross-sectional view of an internal bypass damper with hydraulically-adjustable cross-over, in accordance with an embodiment of the present invention.

The drawings referred to in this description should be understood as not being drawn to scale except if specifically noted.

### DESCRIPTION OF EMBODIMENTS

The detailed description set forth below in connection with the appended drawings is intended as a description of various embodiments of the present invention and is not intended to represent the only embodiments in which the present invention is to be practiced. Each embodiment described in this disclosure is provided merely as an example or illustration of the present invention, and should not necessarily be construed as preferred or advantageous over other embodiments. In some instances, well known methods, procedures, objects, and circuits have not been described in detail as not to unnecessarily obscure aspects of the present disclosure.

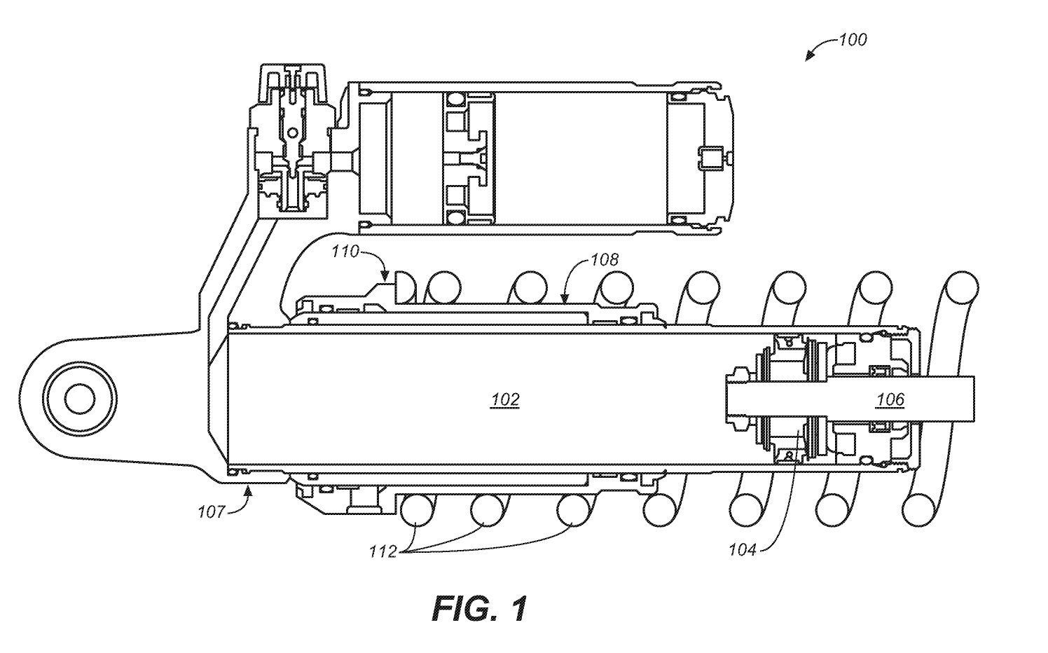

Referring now to FIG. 1, a cut-away view of a damper 100 with hydraulically-adjustable preload is shown in accordance with an embodiment of the present invention. Damper 100 includes a main damper cylinder 102 and a damping piston 104 (coupled to a damping rod 106). Damping piston 104 and damping rod 106 can be moved axially into and out of main damper cylinder 102. In the present embodiment, damper 100 further includes a surface feature (referred to herein as a ridge 107) formed around a portion of the exterior surface of main damper cylinder 102. In the present embodiment, ridge 107 is fixedly coupled to main damper cylinder 102, such that ridge 107 is not moveable with respect main damper cylinder 102.

With reference still to FIG. 1, damper 100 also includes a sleeve 108 having a preload flange 110. As shown in FIG. 1, preload flange 110 protrudes outwardly from sleeve 108 and away from main damper cylinder 102. In one embodiment, preload flange 110 is coupled to sleeve 108. In another embodiment, preload flange 110 is integral with sleeve 108. Sleeve 108, as will be described below in detail, is movable with respect to ridge 107 (and main damper cylinder 102) in a direction along the axis of main damper cylinder 102.

Referring again to FIG. 1, damper 100 also includes a coil spring, typically represented as 112. Coil spring 112 is disposed surrounding the external surface of main damper cylinder 102. In the present embodiment, coil spring 112 has one end abutting preload flange 110, and another end (not shown) coupled to another portion of damper 100.

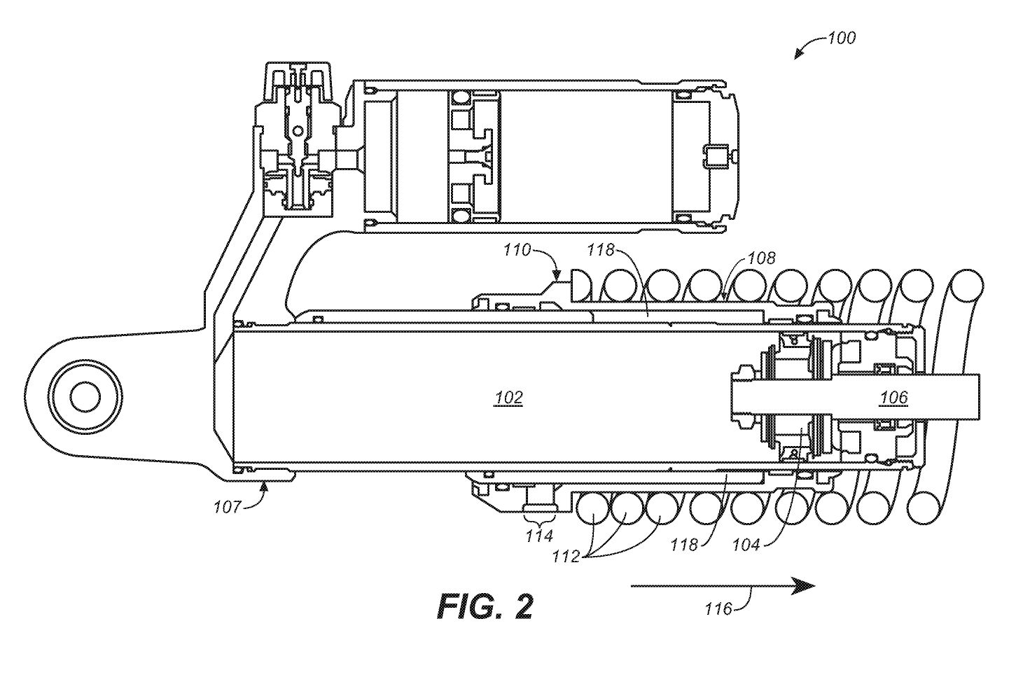

With reference now to FIG. 2, a cut-away view of the damper with hydraulically-adjustable preload of FIG. 1 is shown, wherein coil spring 112 is more compressed than it is in FIG. 1. Specifically, sleeve 108 and ridge 107 are disposed such that hydraulic fluid can be pumped through a port 114 in sleeve 108. The hydraulic fluid will flow between sleeve 108 and ridge 107 and ultimately force sleeve 108 to move with respect to ridge 107 (and main damper cylinder 102) in a direction along the axis of main damper cylinder 102. In the embodiment of FIG. 2, introduction of sufficient hydraulic fluid will cause sleeve 108 to move in the direction indicated by arrow 116. As sleeve 108 moves with respect to ridge 107 a chamber 118 is formed between portions of ridge 107 and sleeve 108. Chamber 118 will be at least partially filled with hydraulic fluid. Thus, by controlling the hydraulic pressure in chamber 118, the position of sleeve 108 with respect to ridge 107, is also controlled.

Referring still to FIG. 2, it should be understood that preload flange 110 moves as sleeve 108 is moved, for example, as shown by arrow 116. Because one end of coil spring 112 abuts (or is coupled to) preload flange 110, movement of sleeve 108 (and, therefore, preload flange 110) in the direction of arrow 116, will cause preload flange 110 to compress coil spring 112. It should be noted that FIG. 2 depicts greater movement between sleeve 108 and ridge 107 than is depicted in FIG. 1. As a result, in FIG. 2, preload flange 110 has compressed coil spring 112 more than preload flange 110 has compressed coil spring 112 in FIG. 1. Therefore, in FIG. 2, preload flange 110 is disposed such that it induces a greater preload on coil spring 112 than the preload induced on coil spring 112 by preload flange 110 when preload flange 110 is disposed as shown in FIG. 1. Thus, by controlling the hydraulic pressure in chamber 118, the amount of preload also controlled.

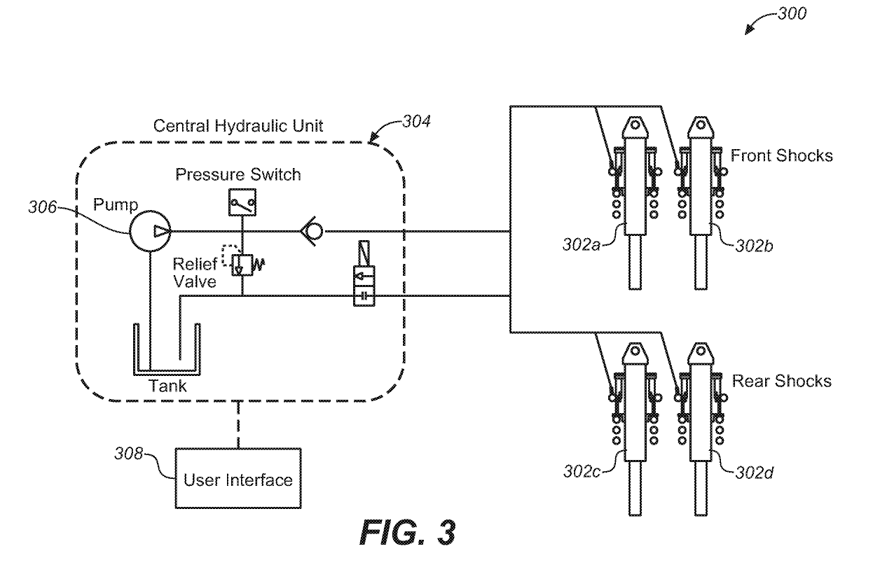

Referring now to FIG. 3, a schematic view is provided which includes four dampers 302a-302d (each of a type such as, for example, damper 100 of FIGS. 1 and 2) with hydraulically-adjustable preload located at respective wheels of a four-wheeled vehicle. In FIG. 3, each of dampers 302a-302d are coupled to a central hydraulic unit 304, in accordance with an embodiment of the present invention. FIG. 3 illustrates that, in one embodiment, central hydraulic unit 304 controls the hydraulic pressure applied to any one or more of dampers 302a-302d (located, e.g., at the: right front shock, left front shock, right rear shock, or left rear shock). Thus, by controlling the hydraulic pressure applied to each of dampers 302a-302d, central hydraulic unit 304 is thereby able to control the amount of preload at each of dampers 302a-302d. Thus, in the present embodiment, unlike many conventional approaches, the operating characteristics of the damper (e.g. preload on any one or more of dampers 302a-302d) can be controlled by a hydraulic pump 306 thereby eliminating the need for manual adjustments by a user of dampers 302a-302d directly at the location of the coil spring or the plurality of coil springs. Also, in various embodiments of the present invention, the user can concurrently make adjustments to the preload of multiple dampers (e.g., more than one of dampers 302a-302d) of a multi-wheeled vehicle.

Referring still to FIG. 3, in another embodiment, a user interface 308 is located, for example, in the cockpit of the vehicle to which dampers 302a-302d are coupled. User interface 308 is coupled, for example, to central hydraulic unit 304. A user is able to select a desired mode (e.g., comfort, sport or race). Once the user selects the desired mode, central hydraulic unit 304 places the appropriate preload on each of dampers 302a-302d to match the user's selected mode. In such an embodiment, the preload for each of dampers 302a-302d is remotely adjustable (e.g., the user controls or adjusts the preload from the vehicle's cockpit). Further, in various embodiments, in addition to being remotely adjustable, the operating characteristics of dampers 302a-302d are controlled without requiring the user to adjust each of dampers 302a-302d individually and separately. That is, once a desired suspension mode is selected by the user, embodiments of the present invention adjust each of dampers 302a-302d as needed to meet the user's desired mode. Hence, in various embodiments of the present invention, a mode selection made by a user, from a location remote from multiple dampers 302a-302d, ultimately results in hydraulic adjustment of multiple dampers 302a-302d to achieve an appropriate damper preload for each of multiple dampers 302a-302d.

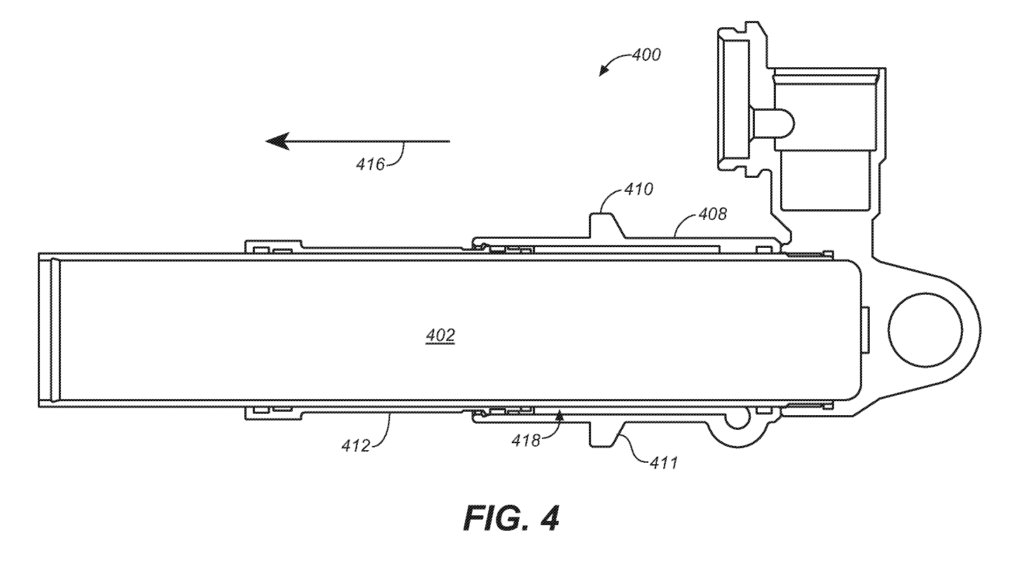

With reference next to FIG. 4, a cut-away view of a damper 100 with hydraulically-adjustable cross-over is shown in accordance with an embodiment of the present invention. Damper 400 includes a main damper cylinder 402 and a damping piston, not shown, coupled to a damping rod, not shown. It will be understood that the damping piston and damping rod can be moved axially into and out of main damper cylinder 402. In the present embodiment, damper 100 further includes a first sleeve 408 formed around a portion of the exterior surface of main damper cylinder 402. In the present embodiment, first sleeve 408 is coupled to main damper cylinder 402, such that first sleeve 408 does not move with respect main damper cylinder 402 during typical operation of damper 400. In various embodiments of the present invention, first sleeve 408 is threadedly coupled to main damper cylinder 402 such that the position of first sleeve 408 can be adjusted axially with respect to main damper cylinder 402 to ultimately dispose first sleeve 408 at a desired position along the length of main damper cylinder 402. In various embodiments, and as described above, once first sleeve 408 is placed at a desired position along the length of main damper cylinder 402, first sleeve 408 will not move with respect main damper cylinder 402 during typical operation (e.g., compression and rebound movement) of damper 400.

With reference still to FIG. 4, first sleeve 408 has a preload flange 410. As shown in FIG. 4, preload flange 410 protrudes outwardly from first sleeve 408 and away from main damper cylinder 402. In one embodiment, preload flange 410 is coupled to first sleeve 408. In another embodiment, preload flange 410 is integral with first sleeve 408. Preload flange 410 also includes a surface 411.

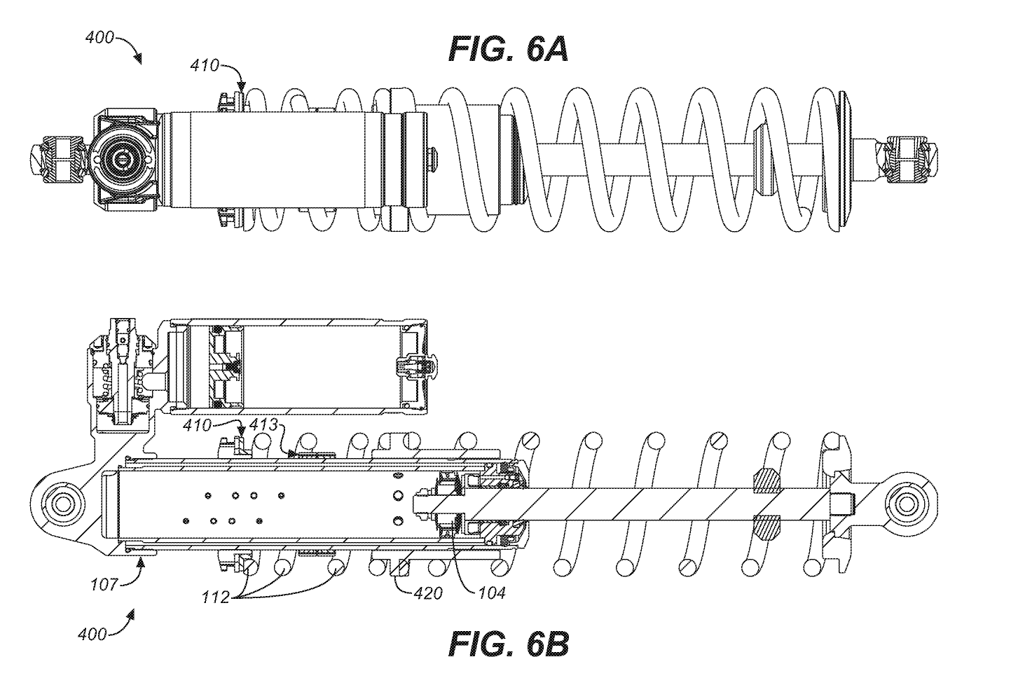

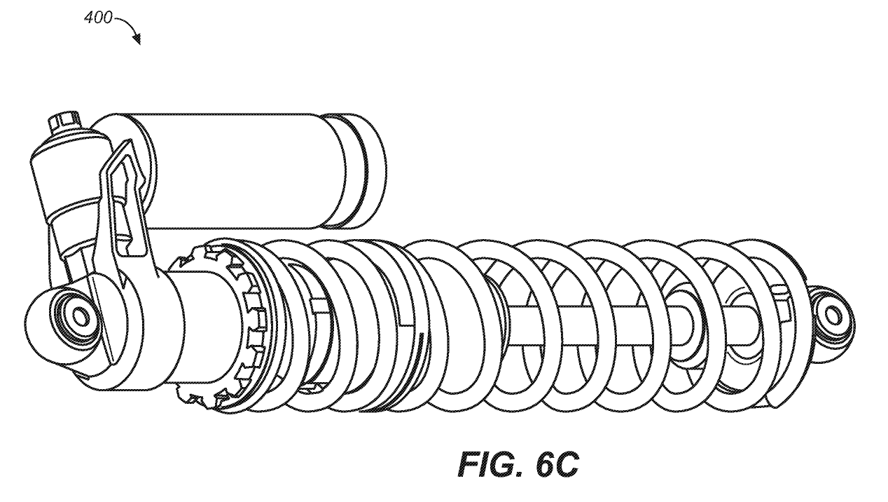

Damper 400 of the present embodiment will typically include two springs (herein referred to as a first (or upper) spring, and a second (or lower) spring). The two springs are not shown in FIG. 4 for purposes of clarity (springs are included in the various illustrations of FIG. 6). The first spring is disposed surrounding the external surface of main damper cylinder 402. In the present embodiment, the first spring has one end abutting preload flange 410 at, for example, front surface 411. Hence, in the present embodiment, preload flange 410 acts as an upper or first spring retainer.

Referring still to FIG. 4, damper 400 also includes a second sleeve 412. Second sleeve 412, as will be described below in detail, is movable with respect to first sleeve 408 (and main damper cylinder 402) in a direction along the axis of main damper cylinder 402. First sleeve 408 and second sleeve 412 are disposed such that hydraulic fluid can be pumped through a port 414 in first sleeve 408. The hydraulic fluid will flow between first sleeve 408 and second sleeve 412 and ultimately force second sleeve 412 to move with respect to first sleeve 408 (and main damper cylinder 402) in a direction along the axis of main damper cylinder 402. In the embodiment of FIG. 4, introduction of sufficient hydraulic fluid will cause second sleeve 412 to move in the direction indicated by arrow 416. As second sleeve 412 moves with respect to first sleeve 408 a chamber or cavity 418 is formed between portions of first sleeve 408 and second sleeve 412. Chamber 418 will be at least partially filled with hydraulic fluid. Thus, by controlling the hydraulic pressure in chamber 418, the position of second sleeve 412 with respect to first sleeve 408, is also controlled.

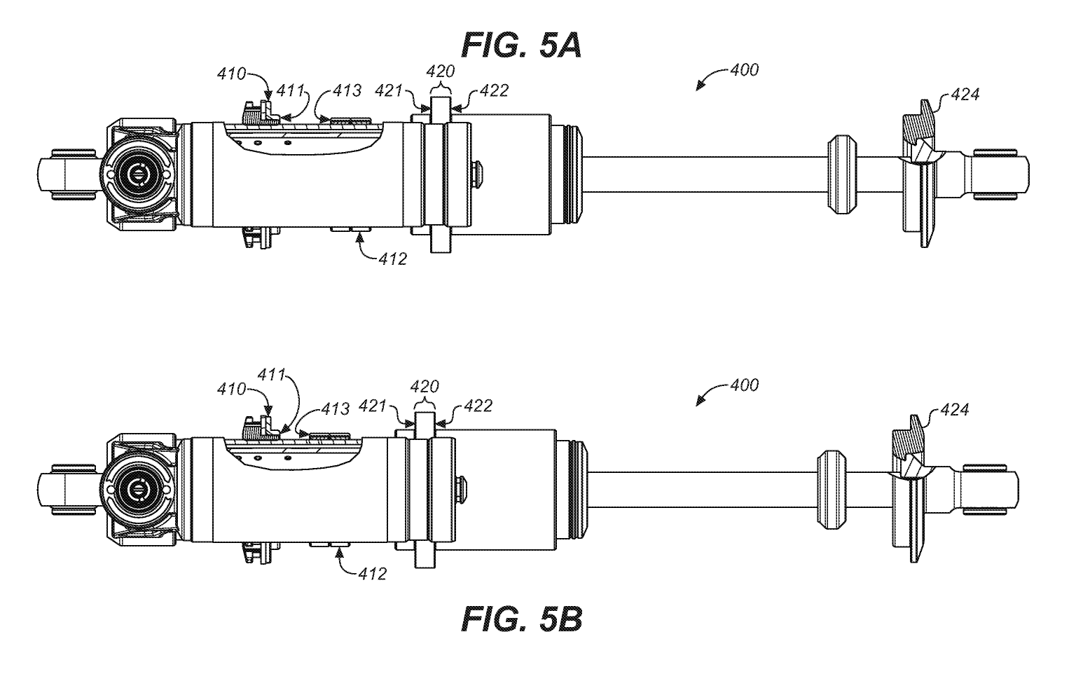

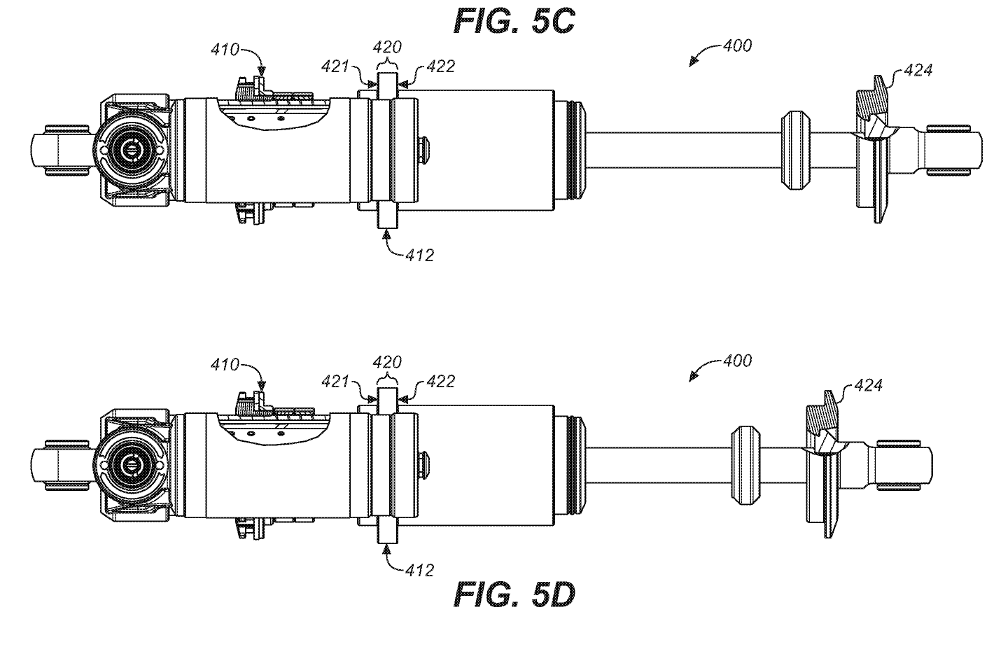

With reference next to FIG. 5A, FIG. 5B, FIG. 5C and FIG. 5D, a detailed description of the structure and operation of embodiments of the present invention is provided. Referring now to FIG. 5A, a partial cut-away view of damper 400 with hydraulically-adjustable cross-over is shown. In the embodiment of FIG. 5A, second sleeve 412 has a spring coupler 420 coupled thereto. Second sleeve 412 further includes a front surface 413. Because front surface 413 and spring coupler 420 are coupled to second sleeve 412, front surface 413 and spring coupler 420 move in unison. That is, the distance between front surface 413 and spring coupler 420 remains constant, regardless of any movement of second sleeve 412. During compression of damper 400, second sleeve 412 having front surface 413 will move towards surface 411. It should be noted that the initial distance (i.e., the distance between surface 411 and front surface 413 when there is no compression of damper 400) between surface 411 and front surface 413 is referred to as the “cross-over” distance.

Thus, by controlling the hydraulic pressure in chamber 418, the position of second sleeve 412 and, hence, spring coupler 420 and front surface 413, with respect to preload flange 410, is also controlled. Spring coupler has a first surface 421 and a second surface 422. In the present embodiment, the first spring, not shown will be disposed having one end thereof abutting preload flange 410 and a second end thereof abutting first surface 421 of spring coupler 420. Thus, in the present embodiment, the amount of compression applied to the first or upper spring is dependent upon the distance between preload flange 410 and first surface 421 of spring coupler 420. Damper 400 also includes a lower flange 424 which will be described further below.

Thus, by controlling the hydraulic pressure in chamber 418, the distance between surface 411 and front surface 413 (i.e., the cross-over distance) is also controlled. Hence, in the present embodiments, the cross-over distance for damper 400 is hydraulically-adjustable. Moreover, embodiments of the present invention enable hydraulically adjusting the cross-over point of the damper without requiring a change in the position of the preload flange 410.

Referring still to FIG. 5A, a second or lower spring is disposed between second surface 422 of spring coupler 420 and lower flange 424. Thus, in the present embodiment, the amount of compression applied to the second or lower spring is dependent upon the distance between second surface 422 of spring coupler 420 and lower flange 424.

Referring now to FIG. 5B, damper 400 is shown compressed, as compared to FIG. 5A. As a result, as depicted in FIG. 5B, second sleeve 412 (including front surface 413 and spring coupler 420) has moved towards first sleeve 408 (including surface 411) as the piston rod moves into main damper cylinder 412 of damper 400. In so doing, the distance between surface 411 and front surface 413 has been reduced. As stated above, during typical operation (e.g., compression and rebound movement) of damper 400, first sleeve 408 does not move with respect main damper cylinder 412. As a result, preload flange 410 remains at the same position with respect to main damper cylinder 412, while spring coupler 420 and first surface 421 move toward preload flange 410. As a result, the first or upper spring is compressed between preload flange 410 and first surface 421 of spring coupler 420 during compression of damper 400 (as long as front surface 413 of second sleeve 412 is not in contact with surface 411 of first sleeve 408). Hence, in one embodiment of the present invention, initial compression of damper 400 results in compression of the first or upper spring. Thus, damper 400 has a first spring curve (corresponding to the first or upper spring) as second sleeve 412 including front surface 413 and spring coupler 420 moves towards first sleeve 408.

Referring now to FIG. 5C, damper 400 is shown further compressed, as compared to FIG. 5B, such that surface 413 of second sleeve 412 contacts surface 411 of first sleeve 408. As stated above, during sufficient compression of damper 400, front surface 413 of second sleeve 412 will eventually contact surface 411 of first sleeve 408. Once front surface 413 contacts surface 411, second sleeve 412 (including spring coupler 420 and first surface 421) no longer move toward first sleeve 408, and hence, there is no further compression of first or upper spring. Thus, second sleeve 412 and particularly front surface 413 functions similar to a cross-over ring. More specifically, when spring coupler 420 and first surface 421 no longer move toward preload flange 410 (due to contact between front surface 413 of second sleeve 412 and surface 411 of first sleeve 408) no further compression of first or upper spring occurs.

Referring now to FIG. 5D, damper 400 is shown further compressed, as compared to FIG. 5C, such that flange 424 has moved toward spring coupler 420. More specifically, in embodiments of the present invention, once spring coupler 420 and first surface 421 no longer move toward preload flange 410 (due to contact between front surface 413 of second sleeve 412 and surface 411 of first sleeve 408), further compression of damper 400 results in flange 424 moving toward spring coupler 420. During such movement of flange 424 (due to further compression of damper 400), the second spring disposed between lower flange 424 and second surface 422 of spring coupler 420 becomes compressed. As a result, the spring curve for damper 400 changes to that corresponding to the second or lower spring. It should be pointed out that the point at which damper 400 has become sufficiently compressed such that spring coupler 420 and first surface 421 no longer move toward preload flange 410 (e.g., when front surface 413 of second sleeve 412 contacts surface 411 of first sleeve 408) is referred to as the “cross-over” point for damper 400.

As described above with respect to FIG. 3, in one embodiment, a central hydraulic unit controls the hydraulic pressure applied to any one or more of the dampers (located, e.g., at the: right front shock, left front shock, right rear shock, or left rear shock). Thus, by controlling the hydraulic pressure applied to each damper, the central hydraulic unit is thereby able to hydraulically adjust the cross-over point (or distance) for each damper. Thus, in the present embodiment, unlike many conventional approaches, the operating characteristics of the damper (e.g., the cross-over point for damper 400) can be controlled by a hydraulic pump thereby eliminating the need for manual adjustments by a user of the damper directly at the location of the springs. Also, in various embodiments of the present invention, the user can concurrently make adjustments to the cross-over point of multiple dampers of a multi-wheeled vehicle.

Also, in another embodiment, a user interface is located, for example, in the cockpit of the vehicle to which the dampers are coupled. The user interface is coupled, for example, to the central hydraulic unit. A user is able to select a desired mode (e.g., comfort, sport or race). Once the user selects the desired mode, the central hydraulic unit hydraulically adjusts the cross-over point on each of the dampers to match the user's selected mode. In such an embodiment, the cross-over point for each of the dampers is remotely adjustable (e.g. the user controls or adjusts the cross-over point from the vehicle's cockpit). Further, in various embodiments, in addition to being remotely adjustable, the operating characteristics of the damper are controlled without requiring the user to adjust each damper individually and separately. That is, once a desired suspension mode is selected by the user, embodiments of the present invention adjust each of the dampers as needed to meet the user's desired mode. Hence, in various embodiments of the present invention, a mode selection made by a user, from a location remote from multiple dampers, ultimately results in hydraulic adjustment of the multiple dampers to achieve an appropriate damper cross-over point for each of the multiple dampers.

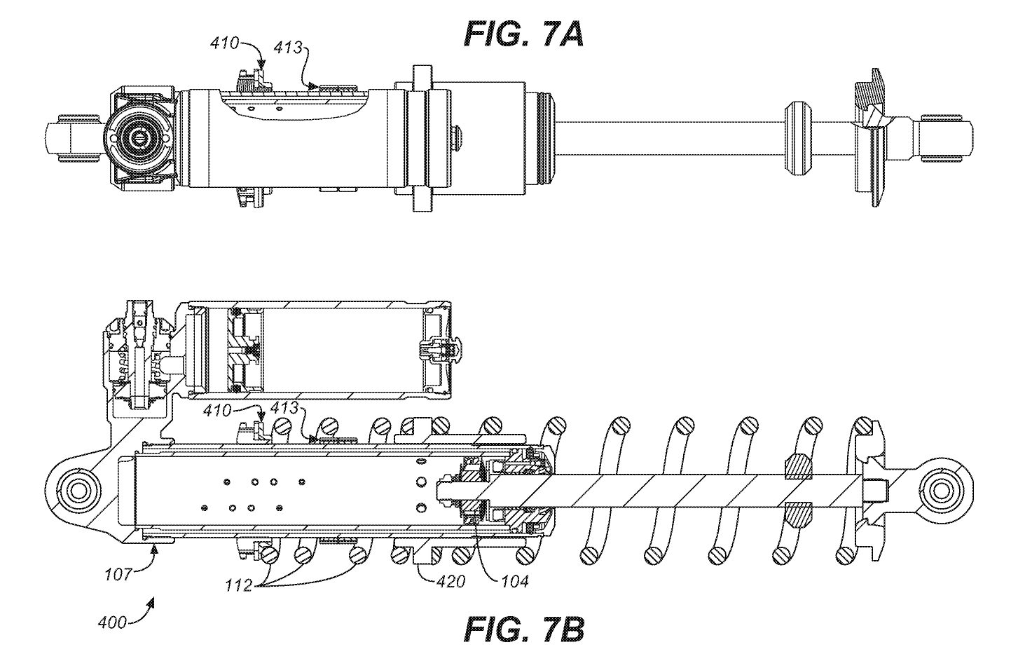

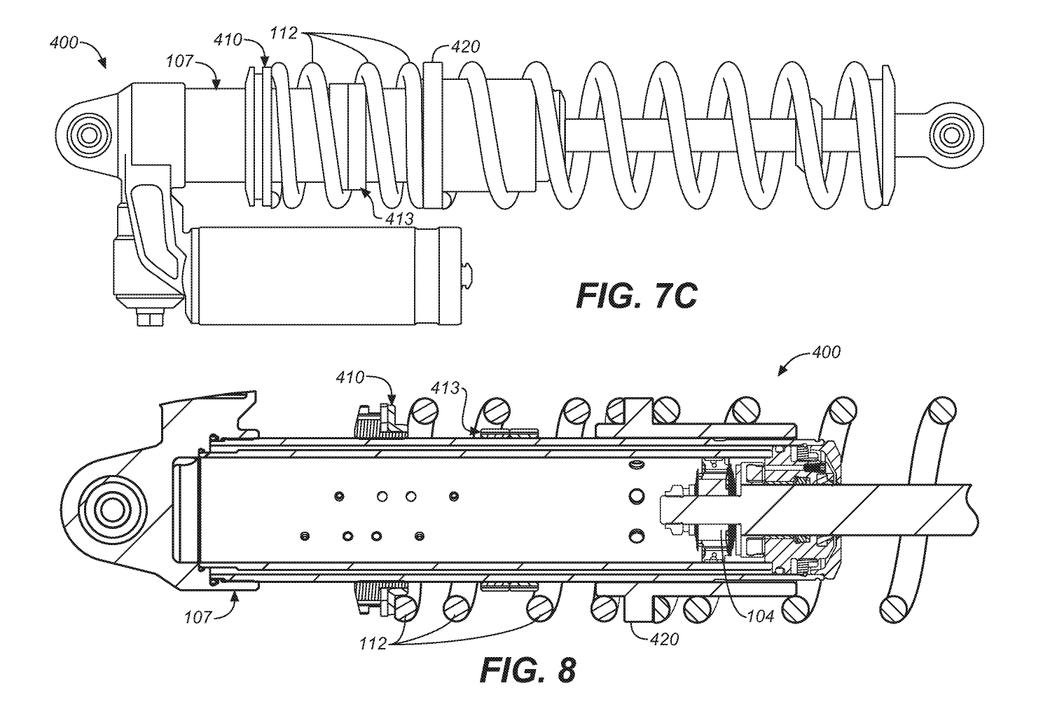

It should further be understood that in various embodiments of the present invention, both the preload and the cross-over point for the damper are hydraulically-adjustable as described above. In one such embodiment, the position of first sleeve 408 of FIG. 4 is hydraulically-adjustable in a manner as was described in detail above in conjunction with the discussion of FIGS. 1-3. Additionally, the position of second sleeve 412 of FIG. 4 is hydraulically-adjustable as was described in detail above in conjunction with the discussion of FIGS. 4-8. Hence, in such an embodiment both the preload and the cross-over point for the damper are hydraulically-adjustable.

What we claim is:

1. A damper having a hydraulically-adjustable preload, said damper comprising:
a main damper cylinder;
a damping piston movably disposed within said main damper cylinder;
a damping rod coupled to said piston;
a surface feature coupled to at least a portion of an exterior surface of said main damper cylinder;
a sleeve coupled to said exterior surface of said main damper cylinder, said sleeve movable with respect to said surface feature in a direction along the axis of said main damper cylinder;
a preload flange coupled to said sleeve;
a spring disposed surrounding at least a portion of said external surface of said main damper cylinder, said spring having one end abutting said preload flange and having another end coupled to said damper; and
said sleeve disposed such that a change in an amount of hydraulic fluid between said sleeve and said surface feature causes said sleeve to move with respect to said surface feature thereby causing said preload flange to change a preload on said spring.

2. A damper having a hydraulically-adjustable cross-over point, said damper comprising:
a main damper cylinder;
a damping piston movably disposed within said main damper cylinder;
a damping rod coupled to said piston;
a lower flange coupled to said damper;
a first sleeve coupled to at least a portion of an exterior surface of said main damper cylinder;
a preload flange coupled to said first sleeve;
a second sleeve coupled to said exterior surface of said main damper cylinder, said second sleeve movable with respect to said first sleeve in a direction along the axis of said main damper cylinder, said second sleeve having a front surface;
a spring coupler coupled to said second sleeve;
a first spring disposed surrounding at least a portion of said external surface of said main damper cylinder, said first spring disposed between said preload flange and said spring coupler;
a second spring disposed surrounding at least a portion of said external surface of said main damper cylinder, said second spring disposed between said spring coupler and said lower flange; and
said second sleeve disposed such that a change in an amount of hydraulic fluid between said first sleeve and said second sleeve causes said second sleeve to move with respect to said first sleeve, thereby changing said cross-over point of said damper.

3. The damper of claim 2, wherein a position of said first sleeve with respect to said exterior surface of said main damper cylinder is hydraulically adjustable.

4. A damper having a hydraulically-adjustable preload and a hydraulically-adjustable cross-over point, said damper comprising:
a main damper cylinder;
a damping piston movably disposed within said main damper cylinder;
a damping rod coupled to said piston;
a surface feature coupled to at least a portion of an exterior surface of said main damper cylinder;
a sleeve coupled to said exterior surface of said main damper cylinder, said sleeve movable with respect to said surface feature in a direction along the axis of said main damper cylinder;
a preload flange coupled to said sleeve;
a first spring disposed surrounding at least a portion of said external surface of said main damper cylinder, said spring having a first end abutting said preload flange and having a second end coupled to said damper;
said sleeve disposed such that a change in an amount of hydraulic fluid between said sleeve and said surface feature causes said sleeve to move with respect to said surface feature thereby causing said preload flange to change a preload on said spring;
a second sleeve coupled to said exterior surface of said main damper cylinder, said second sleeve movable with respect to said first sleeve in a direction along the axis of said main damper cylinder, said second sleeve having a front surface;
a spring coupler coupled to said second sleeve;
a second spring disposed surrounding at least a portion of said external surface of said main damper cylinder, said second spring disposed between said spring coupler and a lower flange; and
said second sleeve disposed such that a change in an amount of hydraulic fluid between said first sleeve and said second sleeve causes said second sleeve to move with respect to said first sleeve, thereby changing said cross-over point of said damper.

5. The damper having a hydraulically-adjustable preload and a hydraulically-adjustable cross-over point of claim 4 wherein said second end of said first spring is disposed abutting said spring coupler.

6. A vehicle and damper assembly having a hydraulically-adjustable preload, said vehicle and damper assembly comprising:
a vehicle;
a damper coupled to said vehicle, said damper having said hydraulically-adjustable preload, said damper comprising:
a main damper cylinder;
a damping piston movably disposed within said main damper cylinder;
a damping rod coupled to said piston;
a surface feature coupled to at least a portion of an exterior surface of said main damper cylinder;
a sleeve coupled to said exterior surface of said main damper cylinder, said sleeve movable with respect to said surface feature in a direction along the axis of said main damper cylinder;
a preload flange coupled to said sleeve;
a spring disposed surrounding at least a portion of said external surface of said main damper cylinder, said spring having one end abutting said preload flange and having another end coupled to said damper; and
said sleeve disposed such that a change in an amount of hydraulic fluid between said sleeve and said surface feature causes said sleeve to move with respect to said surface feature thereby causing said preload flange to change a preload on said spring.

7. A vehicle and damper assembly having a hydraulically-adjustable cross-over point, said vehicle and damper assembly comprising:
a vehicle;
a damper coupled to said vehicle, said damper having said hydraulically-adjustable preload, said damper comprising:
a main damper cylinder;
a damping piston movably disposed within said main damper cylinder;
a damping rod coupled to said piston;
a lower flange coupled to said damper;
a first sleeve coupled to at least a portion of an exterior surface of said main damper cylinder;
a preload flange coupled to said first sleeve;
a second sleeve coupled to said exterior surface of said main damper cylinder, said second sleeve movable with respect to said first sleeve in a direction along the axis of said main damper cylinder, said second sleeve having a front surface;
a spring coupler coupled to said second sleeve;
a first spring disposed surrounding at least a portion of said external surface of said main damper cylinder, said first spring disposed between said preload flange and said spring coupler;
a second spring disposed surrounding at least a portion of said external surface of said main damper cylinder, said second spring disposed between said spring coupler and said lower flange; and
said second sleeve disposed such that a change in an amount of hydraulic fluid between said first sleeve and said second sleeve causes said second sleeve to move with respect to said first sleeve, thereby changing said cross-over point of said damper.

8. The vehicle and damper assembly of claim 7, wherein a position of said first sleeve with respect to said exterior surface of said main damper cylinder is hydraulically adjustable.

9. A vehicle and damper assembly having a hydraulically-adjustable preload and a hydraulically-adjustable cross-over point, said vehicle and damper assembly comprising:
a vehicle;
a damper coupled to said vehicle, said damper having said hydraulically-adjustable preload and said hydraulically-adjustable cross-over point, said damper comprising:
a main damper cylinder;
a damping piston movably disposed within said main damper cylinder;
a damping rod coupled to said piston;
a surface feature coupled to at least a portion of an exterior surface of said main damper cylinder;
a sleeve coupled to said exterior surface of said main damper cylinder, said sleeve movable with respect to said surface feature in a direction along the axis of said main damper cylinder;
a preload flange coupled to said sleeve;
a first spring disposed surrounding at least a portion of said external surface of said main damper cylinder, said spring having a first end abutting said preload flange and having a second end coupled to said damper;
said sleeve disposed such that a change in an amount of hydraulic fluid between said sleeve and said surface feature causes said sleeve to move with respect to said surface feature thereby causing said preload flange to change a preload on said spring;
a second sleeve coupled to said exterior surface of said main damper cylinder, said second sleeve movable with respect to said first sleeve in a direction along the axis of said main damper cylinder, said second sleeve having a front surface;
a spring coupler coupled to said second sleeve;
a second spring disposed surrounding at least a portion of said external surface of said main damper cylinder, said second spring disposed between said spring coupler and a lower flange; and
said second sleeve disposed such that a change in an amount of hydraulic fluid between said first sleeve and said second sleeve causes said second sleeve to move with respect to said first sleeve, thereby changing said cross-over point of said damper.

10. The vehicle and damper assembly of claim 9 wherein said second end of said first spring is disposed abutting said spring coupler.
